(19) United States
(12) Patent Application Publication
(10) Pub. No.: US 2016/0282765 A1
(43) Pub. Date: Sep. 29, 2016

(54) METHODS FOR PRINTING, PRINTED MEDIA AND PACKAGING

(71) Applicant: PLASTO-SAC LTD, Sderot (IL)

(72) Inventors: Yariv SHARMI, Petach Tikva (IL); Gal Segev, Kibutz Maoz Haim (IL)

(73) Assignee: PLASTO-SAC LTD

(21) Appl. No.: 14/669,074

(22) Filed: Mar. 26, 2015

(51) Int. Cl. G03G 15/10

(52) U.S. Cl. CPC G03G 15/10

(57) ABSTRACT

Disclosed are printing media, methods for performing a Liquid Electrophotographic Printing (LEP) processes, methods for producing printed media, printed media, and methods for producing packaging.

### FIELD OF INVENTION

The present invention relates to printing media, methods for performing a Liquid Electrophotographic Printing (LEP) processes, methods for producing printed media, printed media, and methods for producing packaging.

### BACKGROUND

Plastics extrusion is a manufacturing process in which a polymer material is melted and formed into a continuous framework. Extrusion produces items such as pipes, fences, railings, window frames, plastic films and sheeting, thermoplastic coatings and wire insulation. Different techniques for extrusion are known in the art, for example blown film extrusion and cast film extrusion. Extrusion machines are known in the art, for example a blown film extrusion machine as shown in FIG. 1A.

Multi-layer extrusion is the coextrusion of multiple layers of material simultaneously to form a single product. This type of extrusion may include two or more extruders that melt the polymer resin and provide a steady throughput of different raw materials to a single die which will extrude the materials into the desired form. The layer thicknesses are controlled by the speed and size of each individual extruder, providing the resin melt. Co-extrusion allows improvement of a wide range of properties of the produced product, such as oxygen permeability, strength, stiffness, and wear-resistance.

Films and sheets produced by extrusion or coextrusion may be printable products used as printing media for flexography, rotagravure and offset printing methods. Industrial printers can print on exposed surfaces of printable products made of a wide variety of materials including surfaces of polyethylene, polypropylene, polyester, polycarbonate, but in order to optimize ink transfer and adhesion, a pre-treatment process is typically required. In some instances, pre-treatment includes applying a primer coating to a printable surface of a printable product prior to printing. A primer solution is a type of coating that may be applied to improve the ink transfer and printing quality. Exemplary primer solutions that are commercially available include DigiPrime® 4431 by Michelman Inc. (Cincinnati, Ohio, USA) which is a patented flexo and gravure ready coating to provide adhesion of HP Indigo Electrolnk® to most plastic films and papers, and DigiPrime® 1000 (by Michelman Inc.) primer for digital printing that increases adhesion of Indigo inks to uncoated, mottled, semi-gloss and glossy paper grades.

In some cases, surface treatment may also be required in order to optimize the printing process. All materials have an inherent surface energy. Plastics such as polyethylene and polypropylene, are characterized by chemically inert and nonporous surfaces with low surface energy, causing them to be non-receptive to bonding with printing inks, coatings, and adhesives. Surface treatments, such as corona/plasma treatments, modify the surfaces to improve adhesion of the printed color. Corona treatment is performed by using a low temperature corona discharge to change the surface energy of the material. The corona plasma is generated by the application of high voltage to sharp electrode tips which forms plasma at the ends of the sharp tips.

The pre-printing processes such as applying a primer or coating solution to a printable product prior to printing, or performing corona treatment, are not only time-consuming but costly as well. Therefore, it is desirable to produce a printable product, to which the ink will adhere, and which does not require undergoing pre-printing preparation processes (such as priming or corona treatment) prior to printing on the printable product.

### SUMMARY OF THE INVENTION

The present invention relates to printing media, methods for performing a Liquid Electrophotographic Printing (LEP) processes, methods for producing printed media, printed media, and methods for producing packaging.

According to an aspect of some embodiments of the invention, there is provided a method for performing a Liquid Electrophotographic Printing (LEP) process comprising:

a. providing a printing medium, wherein the printing medium comprises an ink-receiving layer and a second layer, the ink-receiving layer and the second layer being coextruded, wherein at least the ink-receiving layer comprises a material selected from the group consisting of ethylene copolymers, alpha-olefin copolymers, polyamides, polyurethanes, polyvinylpyrrolidones, polyethyleneimines, and mixtures thereof; and

b. printing an image on the printing medium.

In some embodiments, the second layer of the printing medium comprises at least one extrudable thermoplastic polymer. The extrudable thermoplastic polymer is any suitable extrudable thermoplastic polymer. In some embodiments, the extrudable thermoplastic polymer of the second layer comprises a polymer selected from the group consisting of polyethylene, polypropylene, polyester (e.g., polyethylene terephthalate), polyamide (e.g., aliphatic polyamides such as Nylon, aromatic polyamides), polycarbonate, acrylonitrile-butadiene styrene, acrylic (PMMA), poly methyl acrylate, polystyrene, polyvinyl chloride and combinations thereof. In some preferred embodiments, the extrudable thermoplastic polymer is selected from the group consisting of polyethylene, polypropylene, polyethylene terephthalate and polyvinyl chloride.

In some embodiments, the printing medium comprises a second layer comprising a polyethylene, that is to say, the second layer of the printing medium comprises polyethylene.

In some embodiments, the polyethylene is selected from the group consisting of low-density polyethylene (LDPE), linear low density polyethylene (LLDPE), medium-density polyethylene (MDPE), high-density polyethylene (HDPE) and combinations thereof.

In some embodiments, the printing medium comprises an ink-receiving layer comprising a material selected from the group consisting of ethylene-vinyl acetate (EVA), ethylene-acrylic acid (EAA), ethylene-methyl methacrylic acid (EMMA), ethylene alpha-olefin polymer, and mixtures thereof, that is to say, the ink-receiving layer of the printing medium comprises a material selected from the group consisting of ethylene-vinyl acetate (EVA), ethylene-acrylic acid (EAA), ethylene-methyl methacrylic acid (EMMA), ethylene alpha-olefin polymer, and mixtures thereof.

In some embodiments, the Liquid Electrophotographic printing process is a one-shot printing process.

In some embodiments, the printing medium is in the form of a film.

In some embodiments, the ink-receiving layer comprises an ethylene copolymer, comprising ethylene copolymerized with at least one acrylic acid as a comonomer. In some embodiments at least one such acrylic acid comonomer is acrylic acid.

In some embodiments, the ink-receiving layer comprises an ethylene copolymer, comprising ethylene copolymerized with at least one acrylate as a comonomer. In some embodiments, at least one such acrylate comonomer is ethyl acrylate. In some embodiments, at least one such acrylate comonomer is butyl acrylate. In some embodiments, at least one such acrylate comonomer is n-butyl acrylate.

In some embodiments, the ink-receiving layer comprises an ethylene copolymer, comprising ethylene copolymerized with at least one vinyl acetate as a comonomer. In some embodiments, at least one such vinyl acetate comonomer is vinyl acetate.

According to an aspect of some embodiments of the invention, there is also provided a printed medium comprising: a. a printing medium as defined herein; and b. a Liquid Electrophotographic printing (LEP) ink layer, wherein the ink layer is in direct contact with the ink-receiving layer of the printing medium.

In some embodiments, the second layer of the printing medium comprises at least one layer comprising an extrudable thermoplastic polymer. The extrudable thermoplastic polymer is any suitable extrudable thermoplastic polymer. In some embodiments, the extrudable thermoplastic polymer of the second layer comprises a polymer selected from the group consisting of polyethylene, polypropylene, polyester (e.g., polyethylene terephthalate), polyamide (e.g., aliphatic polyamides such as Nylon, aromatic polyamides), polycarbonate, acrylonitrile-butadiene styrene, acrylic (PMMA), poly methyl acrylate, polystyrene, polyvinyl chloride and combinations thereof. In some preferred embodiments, the extrudable thermoplastic polymer is selected from the group consisting of polyethylene, polypropylene, polyethylene terephthalate and polyvinyl chloride.

In some embodiments, the printing medium comprises a second layer comprising a polyethylene, that is to say, the second layer of the printing medium comprises polyethylene.

In some embodiments, the polyethylene is selected from the group consisting of low-density polyethylene (LDPE), linear low density polyethylene (LLDPE), medium-density polyethylene (MDPE), high-density polyethylene (HDPE) and combinations thereof.

In some embodiments, the printing medium comprises an ink-receiving layer comprising a material selected from the group consisting of ethylene-vinyl acetate (EVA), ethylene-acrylic acid (EAA), ethylene-methyl methacrylic acid (EMMA), ethylene alpha-olefin polymer, and mixtures thereof, that is to say, the ink-receiving layer of the printing medium comprises a material selected from the group consisting of ethylene-vinyl acetate (EVA), ethylene-acrylic acid (EAA), ethylene-methyl methacrylic acid (EMMA), ethylene alpha-olefin polymer, and mixtures thereof.

According to an aspect of some embodiments of the invention, there is also provided a method for producing a printed medium comprising:

a. coextruding an ink-receiving layer and a second layer thereby obtaining a printing medium as described herein;

b. printing an image on the printing medium using a Liquid Electrophotographic Printing (LEP) process. In some embodiments, the method does not comprise: coating the ink-receiving layer with an adhesive promoter prior to the printing of an image.

According to an aspect of some embodiments of the invention, there is also provided a printed medium obtainable by a method as described herein.

According to an aspect of some embodiments of the invention, there is also provided a method for producing a packaging comprising: a. providing a printed medium as described herein; b. coating the printed medium with an adhesive; c. providing a film; and d. contacting the printed medium and the film. In some embodiments, the film is contacted with the film so that the adhesive bonds the film to the printed medium.

In some embodiments, the second layer of the printed medium comprises a polyethylene and the film comprises a polyester polymer. In some embodiments, the printed medium comprises a polyethylene. In some embodiments, the polyethylene is selected from the group consisting of low-density polyethylene (LDPE), linear low density polyethylene (LLDPE), medium-density polyethylene (MDPE), high-density polyethylene (HDPE) and combinations thereof.

According to an aspect of some embodiments of the invention, there is also provided a method for performing a Liquid Electrophotographic Printing process comprising:

a. providing a printing medium, wherein the printing medium comprises an ink-receiving layer and a second layer, the layers being coextruded, wherein at least ink-receiving layer comprises ethylene copolymers; and

b. printing an image on the printing medium.

According to an aspect of some embodiments of the invention, there is also provided a printed medium comprising:

a. a printing medium as defined above; and

b. a Liquid Electrophotographic printing ink layer wherein the ink layer is in direct contact with the ink-receiving layer.

According to an aspect of some embodiments of the invention, there is also provided a method for producing a printed medium comprising:

a. coextruding an ink-receiving layer and a second layer thereby obtaining a printing medium as defined above;

b. printing an image on the printing medium using a Liquid Electrophotographic Printing (LEP) process. In some embodiments, the method does not comprise: coating the ink-receiving layer with an adhesive promoter prior to the printing of an image.

According to an aspect of some embodiments of the invention, there is also provided a printed medium obtainable by the method described above.

According to an aspect of some embodiments of the invention, there is also provided a method for performing a Liquid Electrophotographic Printing process comprising:

a. providing a printing medium, wherein the printing medium comprises an ink-receiving layer and a second layer, the layers being coextruded, wherein at least the ink-receiving layer comprises a material selected from the group consisting of ethylene-vinyl acetate, ethylene-acrylic acid, ethylene-methyl methacrylate, and mixtures thereof; and

b. printing an image on the printing medium.

According to an aspect of some embodiments of the invention, there is also provided a printed medium comprising:

a. a printing medium as defined above; and

b. a Liquid Electrophotographic printing ink layer wherein the ink layer is in direct contact with the ink-receiving layer.

According to an aspect of some embodiments of the invention, there is also provided a method for producing a printed medium comprising:

a. coextruding an ink-receiving layer and a second layer thereby obtaining a printing medium as defined above;

b. printing an image on the printing medium using a Liquid Electrophotographic Printing (LEP) process. In some embodiments, the method does not comprise: coating the ink-receiving layer with an adhesive promoter prior to the printing of an image.

According to an aspect of some embodiments of the invention, there is also provided a printed medium obtainable by the method as described above.

As used herein and unless otherwise indicated, “electrophotographic printing” refers to the process that provides an image that is transferred from a photo imaging substrate either directly or indirectly via an intermediate transfer member. The image is not substantially absorbed into the photo imaging substrate on which it is applied. The term “liquid electrophotographic printing” refers to electrophotographic printing using a liquid ink composition. The term “electrophotographic printer” and a “liquid electrophotographic printer” is printer capable of performing electrophotographic printing and liquid electrophotographic printing respectively.

### BRIEF DESCRIPTION OF THE DRAWINGS

Some non-limiting exemplary embodiments or features of the disclosed subject matter are illustrated in the following drawings. References to previously presented elements are implied without necessarily further citing the drawing or description in which they appear.

FIG. 1A (prior art) is a schematic illustration of a blown film extrusion machine as known in the art;

FIG. 1B (prior art) is a schematic illustration of a 3-layer die of a multi-layer co-extrusion machine as known in the art;

FIGS. 2A-2B are schematic illustrations, in cross section, of embodiments of printable products according to the teachings herein; and

FIG. 3 is a schematic illustration, in cross section, of an embodiment of a package according to the teachings herein.

It will be appreciated that for simplicity and clarity of illustration, elements shown in the figures have not necessarily been drawn to scale. For example, the dimensions and/or aspect ratio of some of the elements may be exaggerated relative to other elements for clarity. Further, where considered appropriate, reference numerals may be repeated among the figures to indicate corresponding or analogous elements throughout the serial views.

### DETAILED DESCRIPTION

In the context of the present disclosure, without limiting, various aspects of the present invention will be described. For purposes of explanation, specific configurations and details are set forth in order to provide a thorough understanding of the disclosed subject matter. However, it will also be apparent to one skilled in the art that the present invention may be practiced without the specific details presented herein. Furthermore, well known features may be omitted or simplified in order not to obscure the present invention.

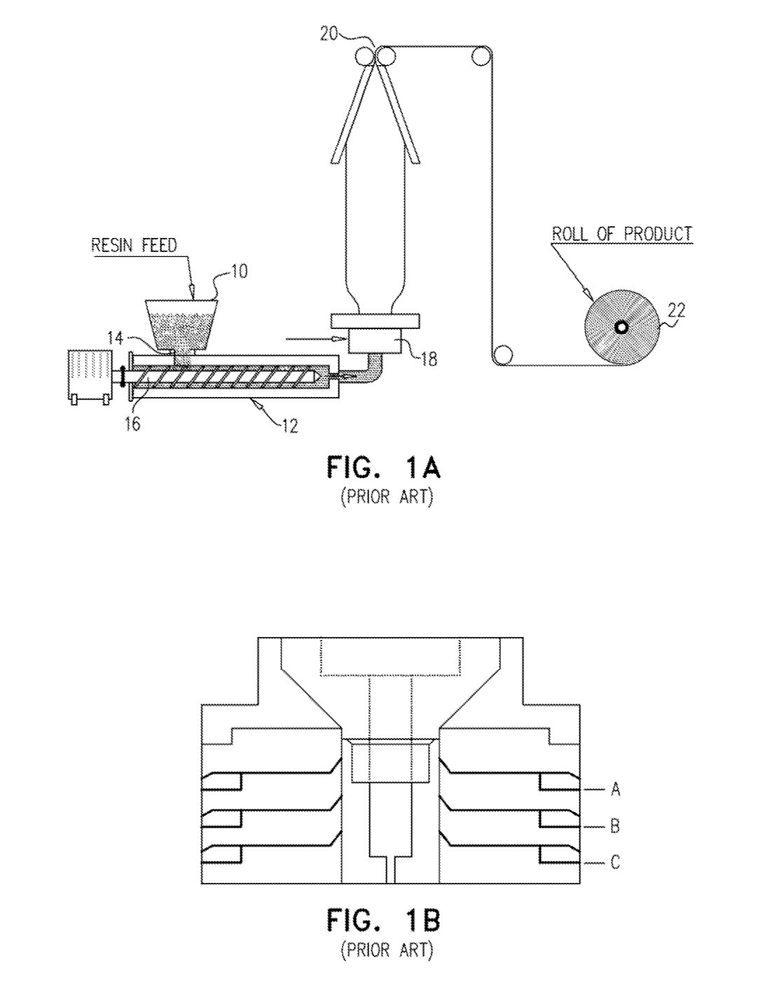

FIG. 1A illustrates a blown film extruder as known in the art that is suitable for implementing some embodiments of the teachings herein. In the extrusion, an extrudable resin of raw materials (e.g., of a polymer such as polyethylene) is fed from a feeding tank 10 into a barrel 12 of the extruder. Additives such as colorants and UV inhibitors can be mixed with the resin before charging the feeding tank 10. The resin enters the barrel 12 through the feed opening 14, and is propelled through the barrel 12 by rotating screw 16 while being heated, to eventually be forced as a melt through a die 18 which shapes the material into an extrudate. The extrudate is first air-cooled, and afterwards is pulled through a set of cooling rolls 20 to obtain a roll 22 of the product. In blown film extrusion, air cooling is performed to stretch the extrudate to obtain very thin sheets of products, and to orient the polymer crystals to increase the strength of the product.

In multi-layer blown film coextrusion, multiple layers of molten raw materials are coextruded through a common die, mutually adhering to form a multilayer product. The resin for each layer is fed through a respective feed opening of a co-extrusion machine. Multi-layer extrusion allows combining the properties of multiple extrudable materials into a single product.

FIG. 1B is a schematic illustration of a three-layer die (e.g. die 18 of FIG. 1A) of a blown film coextrusion machine as known in the art. Each of the input resins A, B and C are fed into a respective feed port of die 18 by a dedicated extruder (not depicted), and are coextruded to emerge from the exit port of the die 18 as a single multilayered product.

Another type of plastics extrusion is cast extrusion, which is typically used to extrude polymer sheet or film. Typically, cast extrusion uses, for example, T-shaped or “coat hanger” dies, which guide the flow of polymer melt from a single round output of the extruder to a thin, flat planar flow, and both die types ensure constant, uniform flow across the entire cross sectional area of the die. The cooling which is performed by pulling through a set of cooling rolls determines the sheet thickness, surface texture and crystal orientation.

It is known to produce products from extrudable polymers such as thermoplastic polymers by extrusion. Known extrusion methods including blown film extrusion, cast sheet extrusion, cast film extrusion and double-bubble extrusion for manufacturing thin polymer films. Resins of polyethylene (PE), polypropylene (PP), polyethylene terephthalate (PET), polyvinyl chloride (PVC), Nylon (polyamide) and polycarbonate (PC) are thermoplastic polymers often manufactured into products using blown film extrusion and cast film extrusion.

In digital offset printing processes, a liquid ink composition (e.g., ElectroInk® by HP Indigo) is applied to a photoconducting image plate, then transferred to a blanket drum to be dried and form a film which is then transferred to a printing medium (also called substrate). In multiple-shot printing processes, the film formed from a specific ink composition is immediately transferred from the blanket drum to the printing medium prior to application of an additional liquid ink composition.

In one-shot printing processes, multiple ink compositions are transferred to the blanket drum to form a plurality of sometimes overlapping films on the blanket drum, and only subsequently transferred from the blanket drum to the printing medium.

Some products produced by extrusion are not suitable to be printing media. For example, some thermoplastic polymers, especially polyolefins like polyethylene and polypropylene, have low surface energy so resist interaction such as adhesion of printed ink or paint.

In some instances, it is possible to apply a primer to a printing medium to ensure adequate transfer of the film from the blanket drum to the printing medium and to ensure adequate adhesion of the film to the printing medium. Primer is applied to a printing medium using any suitable method including flexo-coating, gravure or screen printing. Application of a primer is at least one added step that increases the cost of a printing process. Primers typically include solvents that must be removed, further increasing costs as well as environmental, health and safety dangers.

Alternatively, to improve adhesion of printed ink or paint to an extruded product it is known is to treat the surface to be printed by corona, plasma or flame treatment, thereby modifying the surface to increase surface energy, thereby improving adhesion of printed ink or paint and rendering the product suitable for use as a printing medium. Such treatment constitutes a separate step with additional costs and complexity that may compromise the properties of exceptionally thin (e.g., up to about 200 micrometer thick) products. Further, in some instances such treatments cause increased wear to machines, or cause health and safety challenges, for example, due to the generation of ozone.

The inventors hereby disclose printing media, methods for performing a Liquid Electrophotographic Printing (LEP) processes on the printing media, methods for producing printed media from the printing media, printed media based on the printing media, and methods for producing packaging from the printed media.

The printing media comprises an ink-receiving layer and a second layer, the layers being coextruded, wherein at least the ink-receiving layer comprises a material selected from the group consisting of ethylene copolymers, alpha-olefin copolymers, polyamides, polyurethanes, polyvinylpyrrolidones, polyethyleneimines, and mixtures thereof. The Inventors have found that in some embodiments it is possible to print on such a printing medium using a Liquid Electrophotographic Printing process without using a primer and still achieve acceptable results.

Thus, according to an aspect of some embodiments of the invention, there is provided a method for performing a Liquid Electrophotographic Printing (LEP) process comprising:

a. providing a printing medium, wherein the printing medium comprises an ink-receiving layer and a second layer, the ink-receiving layer and the second layer being coextruded, wherein at least the ink-receiving layer comprises a material selected from the group consisting of ethylene copolymers, alpha-olefin copolymers, polyamides, polyurethanes, polyvinylpyrrolidones, polyethyleneimines, and mixtures thereof; and

b. printing an image on the printing medium.

The printing medium includes an ink-receiving surface which is part of the ink-receiving layer and an opposed surface which is part of the second layer.

In some embodiments, the printing medium is in the form of a film. In some embodiments, the printing medium is an object selected from the group consisting of films, plastic bags, premed pouches, form fill, seal packages, lids for cups and tray, wrap around, tag for plastic bottles, IML in mold labeling and shrink sleeves.

### Ink-Receiving Layer

In addition to providing an ink-receiving surface suitable for printing, the ink-receiving layer may impart one or more properties to a printing medium according to the teachings herein, including one or more of appearance, tactile qualities and weather resistance.

As noted above, an ink-receiving layer of a printing medium according to the teachings herein includes or consists of a material selected from the group consisting of ethylene copolymers, alpha-olefin copolymers, polyamides, polyurethanes, polyvinylpyrrolidones, polyethyleneimines, and mixtures thereof.

As used herein, and unless otherwise indicated, the term ethylene copolymers refers to As used herein, and unless otherwise indicated the term “ethylene copolymer” refers to copolymers that result from the copolymerization of ethylene with comonomers that are selected from the group consisting of vinyl acetates, acrylic acids and acrylates, and mixtures thereof.

Vinyl acetate comonomers for implementing the teachings herein are vinyl esters of carboxylic acids. In some embodiments, an ink-receiving layer according to the teachings herein comprises an ethylene copolymer, comprising ethylene copolymerized with at least one vinyl acetate as a comonomer. In some embodiments, at least one such vinyl acetate comonomer is vinyl acetate (CAS 108-05-4).

Acrylic acid and acrylate comonomers for implementing the teachings herein have a double bond between an alpha and a beta carbon atom. Covalently bonded to the alpha carbon is a carboxylic moiety (COOR), so that the double bond is particularly reactive. Under suitable conditions with which a person having ordinary skill in the art is familiar, such comonomers copolymerize with ethylene through the double bond, producing what are substantially polyethylene polymer molecules with pendant acid or ester functional groups.

In some embodiments, the R of the carboxylic moiety is a hydrogen so that the comonomer is an acrylic acid. In some embodiments, an ink-receiving layer comprises an ethylene copolymer, comprising ethylene copolymerized with at least one acrylic acid as a comonomer. In some embodiments, at least one such acrylic acid comonomer is acrylic acid (CAS 79-10-7).

In some embodiments, the R of the carboxylic moiety is an alkyl group so that the comonomer is an acrylate. In some embodiments, the ink-receiving layer comprises an ethylene copolymer, comprising ethylene copolymerized with at least one acrylate as a comonomer. In some embodiments, at least one such acrylate comonomer is ethyl acrylate (CAS 140-88-5). In some embodiments, at least one such acrylate comonomer is butyl acrylate. In some embodiments, at least one such acrylate comonomer is n-butyl acrylate (CAS 141-32-2). Examples of ethylene copolymers suitable for implementing the teachings herein include Lucalen® A2920M by Basell Polyolefins Company B.V.B.A., the Primacor® family from The Dow Chemical Company and other ethylene copolymers listed in the examples section.

As used herein, and unless otherwise indicated, the term alpha-olefin copolymers refer to poly-alpha-olefin. An alpha-olefin is an alkene having a carbon-carbon double bond located at the a-carbon atom, in other words, the double bond is between the first and second carbons in the molecule. Common alpha-olefins used as co-monomers in the production of polymer alkyl branching groups include but are not limited to 1-hexene, 1-heptene, 1-octene and the like. Examples of such copolymers include Tafmers® from Mitsui chemicals America NY or Affinity® from The Dow Chemical Company.

As used herein, and unless otherwise indicated, the term polyamides refer to a polymer containing amides groups in which the repeating units in the molecular main chain are linked together by amide groups. Examples of such polymers include for instance Macromelt® from Henkel, Germany.

As used herein, and unless otherwise indicated, the term polyurethanes is polymer composed of a chain of organic units joined by urethane bonds.

As used herein, and unless otherwise indicated, the term polyvinylpyrrolidones refer to a polymer that contains or is formed by the polymerization of N-vinylpyrrolidone.

As used herein, and unless otherwise indicated, the term polyethyleneimines refer to amine containing polymer with primary, secondary and tertiary amines. Examples of such copolymers include Polymin® from BASF.

### Second Layer

The second layer may impart one or more properties to a printing medium according to the teachings herein, including one or more of thickness, tear and puncture resistance, sealing properties, chemical resistance, suitability for contact with food and/or pharmaceuticals, and for providing friction for runs against rolls or surfaces.

In some embodiments, a second layer of a printing medium according to the teachings herein comprises a thermoplastic polymer that is processable by extrusion (i.e. that is extrudable). Suitable such polymers include polyethylene polymers, polypropylene polymers, polyethylene terephthalate and polyamide polymers.

In some embodiments, the second layer of the printing medium comprises at least one layer comprising an extrudable thermoplastic polymer. The extrudable thermoplastic polymer is any suitable extrudable thermoplastic polymer. In some embodiments, the extrudable thermoplastic polymer of the second layer comprises a polymer selected from the group consisting of polyethylene, polypropylene, polyester (e.g., polyethylene terephthalate), polyamide (e.g., aliphatic polyamides such as Nylon, aromatic polyamides), polycarbonate, acrylonitrile-butadiene styrene, acrylic (PMMA), poly methyl acrylate, polystyrene, polyvinyl chloride and combinations thereof. In some preferred embodiments, the extrudable thermoplastic polymer is selected from the group consisting of polyethylene, polypropylene, polyethylene terephthalate and polyvinyl chloride.

In some embodiments, the printing medium comprises a second layer comprising a polyethylene, that is to say, the second layer of the printing medium comprises polyethylene.

In some embodiments, the polyethylene is selected from the group consisting of low-density polyethylene (LDPE), linear low density polyethylene (LLDPE), medium-density polyethylene (MDPE), high-density polyethylene (HDPE) and combinations thereof.

In some embodiments, the only thermoplastic polymer making-up the second layer is a polymer selected from the group consisting of polyethylene (PE) polymers, polypropylene (PP) polymers, polyethylene terephthalate (PET) and polyamide (PA) polymers. In some embodiments, the second layer includes LDPE as sole thermoplastic polymer,

In some embodiments, a second layer of a printing medium according to the teachings herein includes additives such as processing agents such as one or more of agents for modifying coefficient of friction, anti-blocking agents, pigments for imparting colors and fillers for imparting physical properties or barrier characteristics.

In some embodiments, a printing medium or printed medium according to the teachings herein has a second layer comprising or consisting of low density polyethylene and an ink-receiving layer comprising a material selected from the group consisting of ethylene-vinyl acetate (EVA) polymer (such as Dupont Escorene® Ultra FL 02020 or EVA-resin escore 123), ethylene acrylic acid (EAA) copolymer, ethylene methyl methacrylate (EMMA) polymer, ethylene alpha-olefin polymer, and mixtures thereof.

In some embodiment, the second layer may include the same material(s) as the ink-receiving layer.

### Internal Layers

In some embodiments, the printing medium includes one or more additional layers, called “internal layers”, that are coextruded with and thereby sandwiched between the ink-receiving later and the second layer. Depending on the embodiment, a printing medium for implementing the teachings herein includes no or one or more internal layers, for example includes no, one, two, three, four, five, six, seven, eight, nine, ten and even more internal layers. When present, the one or more internal layers may provide one or more of color, opacity, stiffness, thickness and barriers to the printing medium.

The one or more internal layers are made of any suitable extrudable polymer. In some embodiments, the internal layers are selected from the types of polymers discussed with reference to the ink-receiving layer. In some embodiments, the internal layers are selected from the types of polymers discussed with reference to the second layer. In some embodiments, the internal layers have the same composition as a respective ink-receiving layer. In some embodiments, the internal layers have the same composition as a respective second layer.

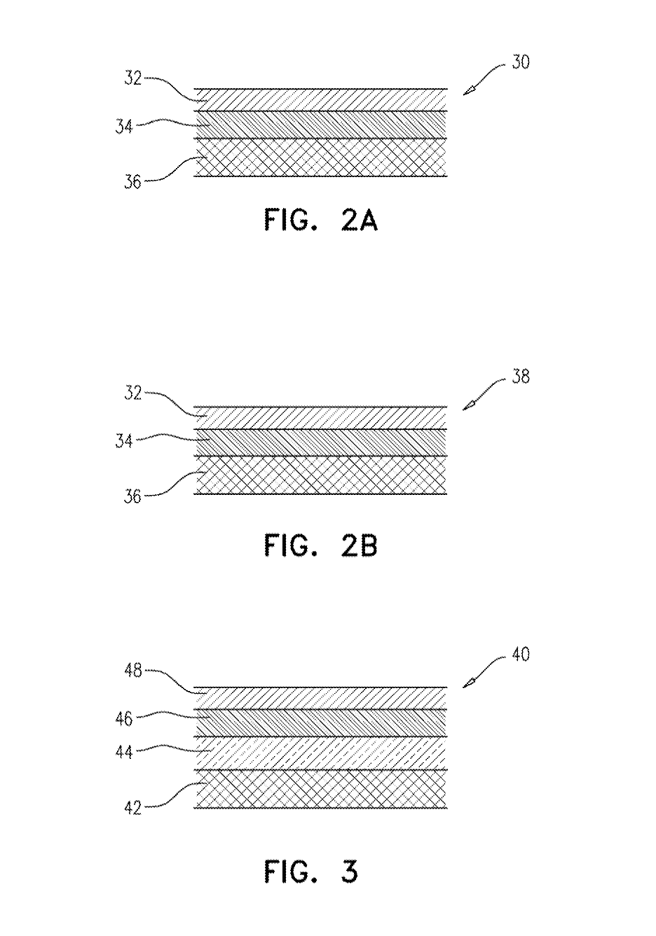

In FIGS. 2A and 2B, two different embodiments of a printing medium suitable for implementing the teachings herein are schematically depicted in cross section. Please note that in the figures, the thickness of the different layers are not drawn to scale.

In FIG. 2A, a printing medium 30 comprises three coextruded layers: an ink-receiving layer 32, an internal layer 34, and a second layer 36. In printing medium 30, only ink-receiving layer 32 comprises a material selected from the group consisting of ethylene copolymers, alpha-olefin copolymers, polyamides, polyurethanes, polyvinylpyrrolidones, polyethyleneimines, and mixtures thereof.

In FIG. 2B, a printing medium 38 comprises three coextruded layers: an ink-receiving layer 32, an internal layer 34, and a second layer 36. In printing medium 38, all three layers 32, 34 and 36 comprise a material selected from the group consisting of ethylene copolymers, alpha-olefin copolymers, polyamides, polyurethanes, polyvinylpyrrolidones, polyethyleneimines, and mixtures thereof.

The absolute and relative thicknesses of the ink-receiving layer, second layer, and if present, internal layers of a given embodiment of a printing medium may be any suitable thickness and depends on the desired properties of the printing medium

In some embodiments, the thickness of each layer of a printing medium is between about 1 micrometer and about 300 micrometer or between about 1 micrometer and about 200 micrometer or between about 1 micrometer and about 100 micrometer or between about 1 micrometer and about 50 micrometer or between about 1 micrometer and about 20 micrometer.

In some embodiments, the total thickness of the ink-receiving layer, second layer, and if present, internal layers of a printing medium is between about 1 micrometer and about 600 micrometer or between about 1 micrometer and about 300 micrometer or between about 1 micrometer and about 120 micrometer or between about 1 micrometer and about 80 micrometer or between about 1 micrometer and about 15 micrometer or between about 20 micrometer and about 60 micrometer.

In some embodiments, the Liquid Electrophotographic printing process of the method for performing LEP printing according to the teachings herein is a one-shot printing process.

According to an aspect of some embodiments of the invention, there is also provided a printed medium comprising: a. a printing medium as defined herein; and b. a Liquid Electrophotographic printing (LEP) ink layer, wherein the ink layer is in direct contact with the ink-receiving layer of the printing medium. By direct contact with is mean that there is no intervening layer (e.g., a primer layer) present between the ink layer and the ink-receiving layer.

According to an aspect of some embodiments of the invention, there is also provided a method for producing a printed medium comprising:

a. coextruding an ink-receiving layer and a second layer thereby obtaining a printing medium as described herein;

b. printing an image on the printing medium using a Liquid Electrophotographic Printing (LEP) process.

Any suitable Liquid Electrophotographic Printing (LEP) process may be used in implementing the teachings herein, for example suitable HP® Digital Indigo printers.

Any suitable ink may be applied in the Liquid Electrophotographic Printing (LEP) process to form the image. In some embodiments, the inks are inks based on ethylene acrylic acid or ethylene methacrylic acids, or ethylene vinyl acetates.

In some embodiments, the method for producing a printed medium does not comprise: coating the ink-receiving layer with an adhesive promoter (e.g., primer) prior to the printing of an image.

According to an aspect of some embodiments of the invention, there is also provided a printed medium obtainable by a method as described herein. In some embodiments, the printed medium is in the form of a film. In some embodiments, the printed medium is an object selected from the group consisting of films, plastic bags, premed pouches, form fill, seal packages, lids for cups and tray, wrap around, tag for plastic bottles, IML in mold labeling and shrink sleeves. In some embodiments, the printed media comprise polyethylene, polyethylene terephthalate, biaxially-oriented polypropylene, cast polypropylene or polyamide films.

According to an aspect of some embodiments of the invention, there is also provided a method for producing a packaging comprising: a. providing a printed medium as described herein; b. coating the printed medium with an adhesive; c. providing a film; and d. contacting the printed medium and the film. In some embodiments, the film is contacted with the film so that the adhesive bonds the film to the printed medium.

In some embodiments, the adhesive is applied so that at least some, preferably all, of the ink making up the image is sandwiched between the ink-receiving layer and the adhesive.

In some embodiments, the second layer of the printed medium comprises a polyethylene and the film comprises a polyester polymer. In some embodiments, the printed medium comprises a polyethylene. In some embodiments, the polyethylene is selected from the group consisting of low-density polyethylene (LDPE), linear low density polyethylene (LLDPE), medium-density polyethylene (MDPE), high-density polyethylene (HDPE) and combinations thereof.

In FIG. 3, an embodiment of a printed medium 40 according to the teachings herein is schematically depicted in cross section. Please note that in the figure, the thickness of the different layers is not drawn to scale. In FIG. 3, printed medium 40 comprises a printing medium 42 according to the teachings herein, an ink layer 44 making up an image, an adhesive layer 46 and a film 48.

In some embodiments, a printed medium according to the teachings herein (e.g., as depicted in FIG. 3) is used in the production of packaging. For example, in some embodiments where a printed medium is used in the production of packaging, the second layer of the printing medium (e.g., 42 in FIG. 3) is polyethylene, especially low-density polyethylene and the film (e.g., 48 in FIG. 3) is a polyester polymer.

In some embodiments, the method for producing packaging is suitable for producing packaging such as films for labels, folding films for packaging or signaling or any other flexible packaging wherein the produced packaging has increased adhesion strength between components and reduced rheology-related failures.

Any suitable method and/or device may be used in implementing the method for producing packaging according to the teachings herein. Some such suitable methods and devices are described in “Fundamentals of Packaging Technology”, Walter Soroka, CPP (editor), Institute of Packaging Professionals 4th Edition 2009 USA page 392.

For instance, in some embodiments lamination is used to produce a package by combining two or more films using an adhesive to form a single laminated film. Suitable adhesives include solvent-based (including water as a solvent) adhesives, solvent-less adhesives, UV-curable adhesives and extrusion lamination adhesion.

### Experimental

### Preparation of Printing Media

Embodiments of printing media in accordance with the teachings herein were prepared by coextrusion in a blown-film coextruder (Varex by Windmoeller & Hoelscher Corporation, Lincoln, R.I., USA), each one of the embodiments produced by coextrusion of an ink-receiving layer directly contacting a second layer and optionally an additional layer. Percentages listed are weight percentages.

Ink transfer was evaluated by printing on a sample of printing media using a Hewlett-Packard Indigo WS6800 Digital Press, ink (HP Indigo Electrolnk®).

Ink adhesion was evaluated using a standard tape test.

MDUG1955 (also called Roll Number 1)

Ink receiving layer of 100% Elvaloy® 2715 by DuPont™, a copolymer resin of ethylene and ethyl acrylate comprising 15% by weight of the ethyl acrylate.

Second layer of 87% LDPE (LD152), 12% LLDPE (White 1588/1584) and 1% anti-oxidant.

Third Layer of 86.5% LDPE (LD152), 11% LLDPE (White 1588/1584), 1% silica antiblock, 1% anti-oxidant and 0.5% elastomer processing aid.

Ink transfer to the ink receiving layer was good. Ink adhesion was measured to be 70-80%.

### Roll Number 2

Ink receiving layer of 50% Elvaloy® 2715 by DuPont™, a copolymer resin of ethylene and ethyl acrylate comprising 15% by weight of the ethyl acrylate and 50% LDPE.

Ink transfer to the ink receiving layer was good. Ink adhesion was poor.

### Roll Number 3

Ink receiving layer of 100% Amplify® EA by Dow™, a copolymer resin of ethylene and ethyl acrylate comprising 15% by weight of the ethyl acrylate.

Ink transfer to the ink receiving layer was good. Ink adhesion was insufficient.

### MDUG1956

Ink receiving layer of 100% Lucalen® A2920M by Bassell™, a copolymer resin of ethylene, 4% acrylic acid and 7% n-butyl acrylate.

Second layer of 87% LDPE (LD152), 12% LLDPE (White 1588/1584) and 1% anti-oxidant.

Third Layer of 86.5% LDPE (LD152), 11% LLDPE (White 1588/1584), 1% silica antiblock, 1% anti-oxidant and 0.5% elastomer processing aid.

Ink transfer to the ink receiving layer was good. Ink adhesion was good.

### PDUG2583

Ink receiving layer of 100% Primacor® 1410 by Dow™, a copolymer resin of ethylene and 9.7% acrylic acid.

Second layer of 87% LDPE (LD152), 12% LLDPE (White 1588/1584) and 1% anti-oxidant.

Third Layer of 86.5% LDPE (LD152), 11% LLDPE (White 1588/1584), 1% silica antiblock, 1% anti-oxidant and 0.5% elastomer processing aid.

Ink transfer to the ink receiving layer was good. Ink adhesion was good.

### PDUG2584

Ink receiving layer of 100% Lucalen® A2700H by Bassel™, a copolymer resin of ethylene and 16% n-butyl acrylate.

Second layer of 87% LDPE (LD152), 12% LLDPE (White 1588/1584) and 1% anti-oxidant.

Third Layer of 86.5% LDPE (LD152), 11% LLDPE (White 1588/1584), 1% silica antiblock, 1% anti-oxidant and 0.5% elastomer processing aid.

Ink transfer to the ink receiving layer was good. Ink adhesion was very poor.

### MDUG1824

Ink receiving layer of 98% ethylene vinyl acetate (a copolymer resin of ethylene and 18% vinyl acetate), 1% silica antiblock and 1% processing aid to prevent adhesion of the product to metal during the manufacturing process.

Second layer of 1% antioxidant AO25, 87.5% LDPE (LD152 by Exxon Mobil) and 11.5% LLDPE (White 1588/1584).

Third Layer of 1% silica antiblock, 1% antioxidant AO25, 86.5% LDPE (LD152 by Exxon Mobil), 11% LLDPE (White 1588/1584) and 0.5% elastomer processing aid.

### MDUG1731

Ink receiving layer of 93% EVA119 by Exxon Mobil (a copolymer resin of ethylene and 18% vinyl acetate), 5% EVA328 by Exxon Mobil (a copolymer resin of ethylene and 27% vinyl acetate), and 2% processing aid to prevent adhesion of the product to metal during the manufacturing process.

Second layer of 33.5% LDPE (320E MFI-1 by Dow), 35% LLDPE (62009H), 1.5% MB GREEN ME51444 that colored the layer green and 30% Formosa 3728 HDPE produced by Formosa Plastics.

Third Layer of 2% HT6000 MI-2 (LLDPE based Talc Concentrate by Heritage Plastics Inc), 33% LDPE (320E MFI-1 by Dow), 35% LLDPE (62009H), 29.5% Formosa 3728HF HDPE produced by Formosa Plastics and 0.5% elastomer processing aid (OI970LL) to prevent adhesion of the product to metal during the manufacturing process.

As used herein the term ‘configuring’ and/or ‘adapting’ for an objective, or a variation thereof, implies using components in a manner and/or mechanism designed for achieving the objective.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for performing a Liquid Electrophotographic Printing process comprising:
a. providing a printing medium, wherein said printing medium comprises an ink-receiving layer and a second layer, said layers being coextruded, wherein at least said ink-receiving layer comprises a material selected from the group consisting of ethylene copolymers, alpha-olefin copolymers, polyamides, polyurethanes, polyvinylpyrrolidones, polyethyleneimines, and mixtures thereof; and
b. printing an image on said printing medium.

2. The method according to claim 1, wherein said second layer comprises at least one extrudable thermoplastic polymer.

3. The method according to claim 1, wherein said printing medium comprises a second layer comprising a low-density polyethylene and an ink-receiving layer comprising a material selected from the group consisting of ethylene-vinyl acetate, ethylene-acrylic acid, ethylene-methyl methacrylic acid, ethylene alpha-olefin polymer, and mixtures thereof.

4. The method according to claim 1, wherein the Liquid Electrophotographic printing process is a one-shot printing process.

5. The method according to claim 1, wherein said printing medium is in the form of a film.

6. The method according to claim 1, wherein said ink-receiving layer comprises an ethylene copolymer, comprising ethylene copolymerized with at least one acrylic acid as a comonomer.

7. The method of claim 6, wherein at least one said acrylic acid comonomer is acrylic acid.

8. The method according to claim 1, wherein said ink-receiving layer comprises an ethylene copolymer, comprising ethylene copolymerized with at least one acrylate as a comonomer.

9. The method of claim 8, wherein at least one said acrylate comonomer is ethyl acrylate.

10. The method of claim 8, wherein at least one said acrylate comonomer is butyl acrylate.

11. The method of claim 8, wherein at least one said acrylate comonomer is n-butyl acrylate.

12. The method according to claim 1, wherein said ink-receiving layer comprises an ethylene copolymer, comprising ethylene copolymerized with at least one vinyl acetate as a comonomer.

13. The method according to claim 12, wherein at least one said vinyl acetate comonomer is vinyl acetate.

14. A method for performing a Liquid Electrophotographic Printing process comprising:
a. providing a printing medium, wherein said printing medium comprises an ink-receiving layer and a second layer, said layers being coextruded, wherein at least said ink-receiving layer comprises ethylene copolymers; and
b. printing an image on said printing medium.

15. A method for performing a Liquid Electrophotographic Printing process comprising:
a. providing a printing medium, wherein said printing medium comprises an ink-receiving layer and a second layer, said layers being coextruded, wherein at least said ink-receiving layer comprises a material selected from the group consisting of ethylene-vinyl acetate, ethylene-acrylic acid, ethylene-methyl methacrylate, and mixtures thereof; and
b. printing an image on said printing medium.

16. A printed medium comprising:
a. a printing medium as defined in claim 14; and
b. a Liquid Electrophotographic printing ink layer wherein said ink layer is in direct contact with said ink-receiving layer.

17. A printed medium comprising:
a. a printing medium as defined in claim 15; and
b. a Liquid Electrophotographic printing ink layer wherein said ink layer is in direct contact with said ink-receiving layer.

18. A method for producing a printed medium comprising:
a. coextruding an ink-receiving layer and a second layer thereby obtaining a printing medium as defined in claim 14;
b. printing an image on said printing medium using a Liquid Electrophotographic Printing (LEP) process.

19. A method according to claim 18, wherein the method does not comprise:
coating said ink-receiving layer with an adhesive promoter prior to said printing of an image.

20. A method for producing a printed medium comprising:
a. coextruding an ink-receiving layer and a second layer thereby obtaining a printing medium as defined in claim 15;
b. printing an image on said printing medium using a Liquid Electrophotographic Printing (LEP) process.

21. A method according to claim 20, wherein the method does not comprise:
coating said ink-receiving layer with an adhesive promoter prior to said printing of an image.

22. A printed medium obtainable by a method according to claim 19.

23. A printed medium obtainable by a method according to claim 21.
